(19) United States
(12) Patent Application Publication
(10) Pub. No.: US 2021/0135353 A1
(43) Pub. Date: May 6, 2021

(54) Two-Dimensional Phased Array Antenna

(71) Applicant: RFISee LTD, Raanana (IL)

(72) Inventors: Eran Socher, Raanana (IL); Nir Mor, Kadima-Zoran (IL)

(73) Assignee: RFISee LTD, Raanana (IL)

(21) Appl. No.: 16/618,388

(22) PCT Filed: Jun. 2, 2019
(86) PCT No.: PCT/IL2019/050626

§ 371 Date: Dec. 1, 2019

Related U.S. Application Data
(60) Provisional application No. 62/566,628, filed on Oct. 2, 2017.

(51) Int. Cl. H01Q 1/52; H01Q 21/06; H01Q 3/34; G01S 13/02

(52) U.S. Cl. CPC H01Q 1/525; H01Q 21/065; G01S 2013/0245; G01S 13/02; H01Q 3/34

(57) ABSTRACT

Use of arrays for both transmit and receive operations in a radar system is made practical by means of a geometric configuration for receiver and transmitter array, for which the peaks of the transmit signal fall on the troughs of the receive signal grating lobes, causing a cancellation of these undesirable grating lobes to a large degree. The use of arrays for both transmit and receive allows for a large reduction in number of individual antennas required

### FIELD OF THE INVENTION

The present invention relates generally to the field of antennas, particularly phased-array antennas.

### BACKGROUND OF THE INVENTION

Phased array antennas use many individual antennas to form antenna beams useful for directional transmission and reception without requiring physical movement of the antenna. Each individual antenna is generally provided with a phase shifter. Beams are formed by shifting the relative phases of the radiation sent by the antennas, producing constructive/destructive interference in controllable directions.

Such antennas are routinely used to electronically scan a scene in transmit and/or receive modes using wireless transceivers. As mentioned, operation is based on control of an effective beam direction by control over the individual phases of the transmitting elements. These elements may be positioned to form a one-dimensional array (vector) or a two-dimensional array (matrix), these being two examples from a wide range of possibilities. In receive mode the effect of receiving selectively from a direction narrower than the main lobe of each antenna array element can be achieved by adding individual phases to the signals received from each element, either in the RF front-end or later in signal processing (this being referred to as digital beam forming).

In general, for a phase array to cover a wide field of view, each antenna element in the array needs to be small enough that:

Dₑₗₑₘₑₙₜ≤λ/sin(α_{FOV})

where D is the element aperture, λ is the wavelength of radiation and α_{FOV} is the angular field of view.

Similarly, if a certain angular resolution is desired from the phase array, the array beam width (which sets the pixel size in 2D Radar imaging) has to be small enough to allow this resolution. This size is controlled by the total array aperture D_{array} through:

D_{array}≥λ/sin(αₚᵢₓₑₗ)

As a result, a 1D phase array covering α_{FOV} with αₚᵢₓₑₗ resolution would require a vector array having a number of elements of about D_{array}/Dₑₗₑₘₑₙₜ

N=sin(α_{FOV})/sin(αₚᵢₓₑₗ)≈α_{FOV}/αₚᵢₓₑₗ

which is also the number of imaged pixels. In a 2D phase array, the required total number of antenna elements in the array would also correspond approximately to the total number of angular pixels that need imaging, or N×M for an array of N×M elements.

Thus, in a 2D phased array radar that must cover for example an angular field of view (solid angle) of 100°×100° with a resolution of 1°×1° we could have one transmitter that constantly illuminates the whole field of view (hereinafter FOV) and a 100×100 antenna phased array with 10,000 receivers to achieve the required resolution. Alternatively, we can have 10,000 transmitting elements in a phase array and a single wide-angle receiving element. Even if array elements (either transmit or receive) do not include the full Rx or Tx chain, they need at least active phase control. To provide 10,000 such active phase control elements is not practical in a cost effective system implementation.

The phase array beam width is controlled by the total array aperture, even if not all aperture area is populated with antenna elements. In the extreme, it is enough to have just two elements at the edge of the aperture to set the aperture size and thus the beam width. However a problem arises concerning the grating lobes: in addition to the main narrow beam (or lobe), missing elements in the array will generate additional lobes within the total FOV set by the antenna element aperture. Grating lobes appear as duplicates of the main lobe at angles with periodicity inversely proportional to the pitch P of the element in the array (the pitch is the distance between adjacent array element centers):

sin(ϕₙ)=±mλP

where ϕₙ are the directions of the lobes, m=0, 1, 2, . . . and P is the element pitch. As a result, grating lobes will be generated as P is increased compared with the element aperture Dₑₗₑₘₑₙₜ and they will number about P/Dₑₗₑₘₑₙₜ.

It would thus serve to answer a long-felt need, were a phased-array antenna to be invented, that was able to increase the resolution obtained for a given number of individual phase-controlled antenna, or equivalently, that was able to achieve a given resolution with fewer elements.

### SUMMARY OF THE INVENTION

The patent uses a combination of transmit and receive phase arrays that allow a significant reduction of the number of elements in the receive/transmit circuit chain, without degradation of FOV or angular resolution.

In layman's terms a geometric configuration for receiver and transmitter arrays has been found that allows the peaks of the transmit signal to fall on the troughs of the receive signal lobes, causing a large cancellation of the undesired grating lobes (which obscure one's knowledge from which direction a given signal is coming).

In a simplified one dimensional embodiment, both transmit and receive antenna array elements have the same aperture Dₑₗₑₘₑₙₜ. Note this is an example where this choice has been made for simplicity; in fact the aperture may be made different for transmit and receive arrays.

The receive phase array covers an aperture of D_{RXarray}=NDₑₗₑₘₑₙₜ>>Dₑₗₑₘₑₙₜ and element pitch of Pᵣₓ=KDₑₗₑₘₑₙₜ>Dₑₗₑₘₑₙₜ.

The transmitter is also a phase array, but with an aperture of D_{Txarray}=P_{Rx}=KDₑₗₑₘₑₙₜ and a pitch of Dₑₗₑₘₑₙₜ. As a result, the transmitter array beam width would can cover the entire FOV without any grating lobes. The illuminating transmitter can choose the main receive lobe direction so as to make the parasitic receive array grating lobes non-responsive. The receiver grating lobes in this case fall on those angles where the transmitter pattern has nulls, which will make the effective radar pattern much more selective.

### BRIEF DESCRIPTION OF THE DRAWINGS

Embodiments and features of the present invention are described herein in conjunction with the following drawings:

FIG. 1 illustrates an array element pattern, for a 5-element receive array pattern with 2.5λ pitch at boresight, 5-element transmit array pattern with λ/2 pitch at boresight and the effective transmit-receive pattern at boresight.

FIG. 2 illustrates beam patterns of a 5-element receive array with 2.5λ pitch with 2.5° resolution.

FIG. 3 illustrates beam patterns of a 5-element transmit array with λ/2 pitch with 12.5° resolution.

FIG. 4 shows effective beam patterns of a 5-element receive array with 2.5λ pitch with 2.5° resolution selected by the beams of a 5-element transmit array with λ/2 pitch with 12.5° resolution.

FIG. 5 illustrates a two dimensional implementation of the transmit/receive phased array concept.

### DEFINITIONS

‘Phase array’ or ‘phased array’ hereinafter refers to a set of antenna elements each of which has a controllable phase, these elements together being capable of beam steering a transmit or receive antenna beam.

‘Resolution’ hereinafter refers to the angular resolving power of a given phase array.

‘Field of view’ hereinafter refers to the solid angle a given phase array can transmit to and/or receive from.

‘Pitch’ hereinafter refers to the physical spacing between antenna elements in a phase array. For instance, a regular rectangular grid of antenna elements with spacing of 5 mm in the x-direction, between adjacent columns of antenna elements, and 7 mm in the y-direction, between adjacent rows of antenna elements, has a pitch of 5 mm×7 mm.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail. Furthermore just as every particular reference may embody particular methods/systems, yet not require such, ultimately such teaching is meant for all expressions notwithstanding the use of particular embodiments.

The invention solves the ‘resolution problem’ outlined above, namely that for a given number of imaged pixels a standard phase array will require approximately the same number of individual phase-controlled antenna elements.

Use of arrays for both transmit and receive operations in a radar system is made practical by means of a geometric configuration for receiver and transmitter arrays for which the peaks of the transmit signal fall on the troughs of the receive signal grating lobes, causing a cancellation of these undesirable grating lobes to a large degree.

As explained above in the brief description, a distinguishing feature of the invention involves the use of phased arrays for both transmit and receive operations. The receive phase array covers an aperture of D_{RXarray}=NDₑₗₑₘₑₙₜDₑₗₑₘₑₙₜ (N being for example 25) and element pitch of P_{Rx}=KDₑₗₑₘₑₙₜ>Dₑₗₑₘₑₙₜ (K being for example 5). With an element FOV of 75° for example, the receive array beam width (and resolution) would be about 3° and grating lobe periodicity would be about 15°. At the same time, the transmitter is also a phase array, but with an aperture of D_{Txarray}=P_{Rx}=KDₑₗₑₘₑₙₜ and a pitch of Dₑₗₑₘₑₙₜ. As a result, the transmitter array beam width would be about 15°, covering the entire FOV without any grating lobes. As a result, the illuminating transmitter can choose the correct main receive lobe direction so as to make the parasitic receive array grating lobes non-responsive. The receiver grating lobes would fall on the angle where the transmitter pattern will have nulls, which will make the effective radar pattern much more selective.

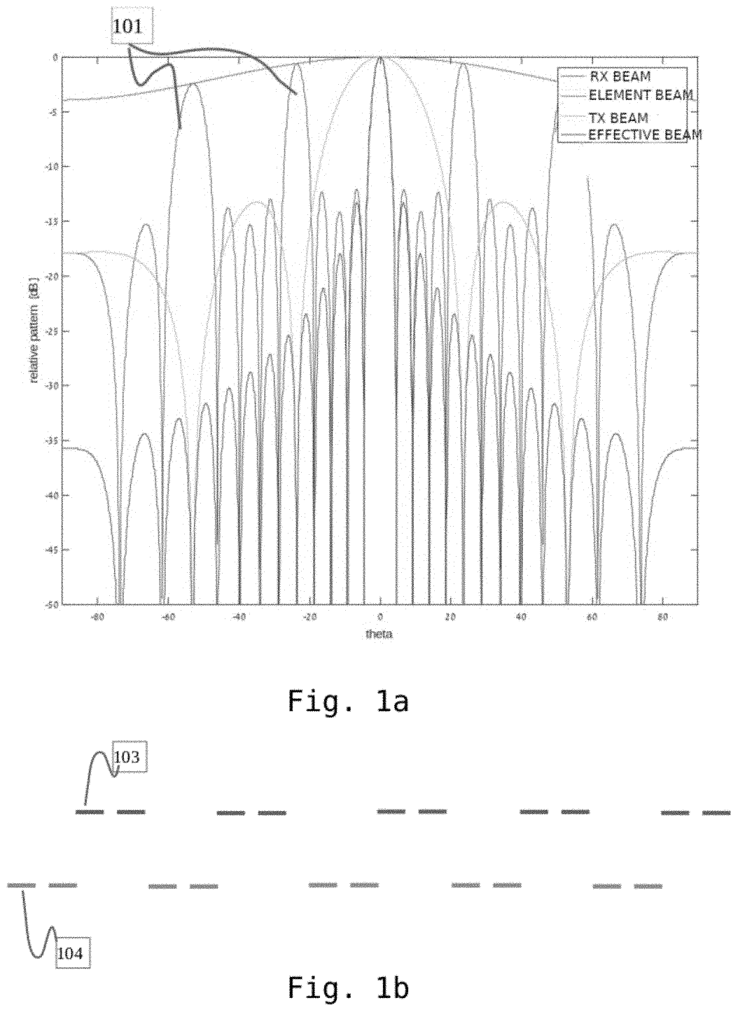

FIG. 1a illustrates an array element pattern for a 5-element receive array pattern with 2.5λ pitch at boresight, 5-element transmit array pattern with λ/2 pitch at boresight (direction of maximum gain), and the effective transmit-receive pattern at boresight. Note that the peaks of the receive beam are at zeros of the transmit beam. The receive (104) and transmit (103) arrays are shown schematically in FIG. 1B.

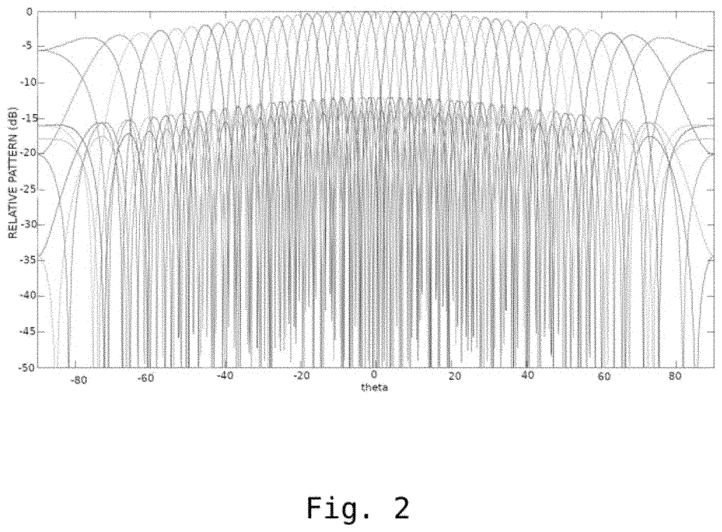

FIG. 2 shows beam patterns for a 5-element receive array with 2.5λ pitch with 2.5° resolution.

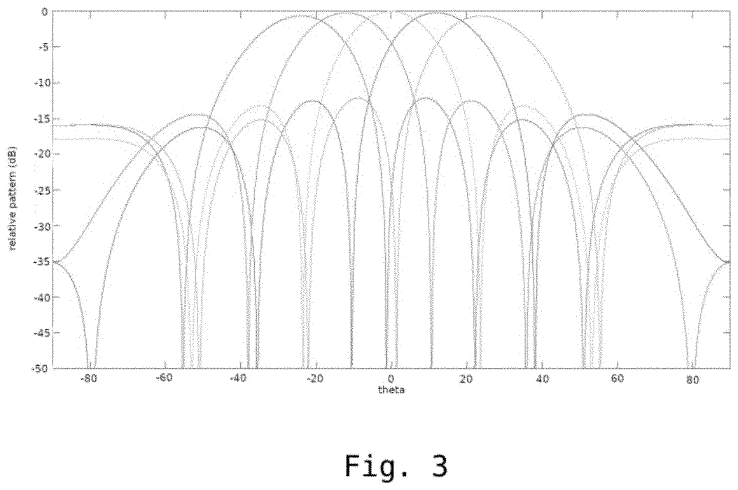

FIG. 3 shows beam patterns for a 5-element transmit array with λ/2 pitch with 12.5° resolution.

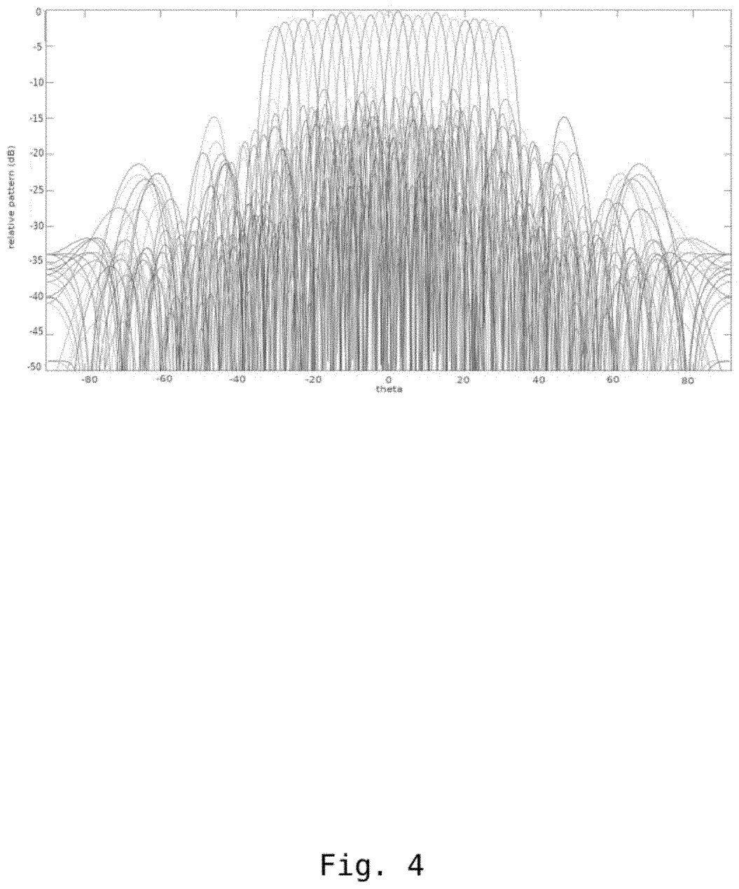

FIG. 4 shows effective beam patterns for a 5-element receive array with 2.5λ pitch with 2.5° resolution selected by the beams of a 5-element transmit array with λ/2 pitch with 12.5° resolution.

The same principle can be applied also in a two dimensional array. Applying the same design principles in both dimensions would yield a 5×5 transmit array with Dₑₗₑₘₑₙₜ pitch and 5Dₑₗₑₘₑₙₜ×5Dₑₗₑₘₑₙₜ total size and 5×5 receive array with 5Dₑₗₑₘₑₙₜ pitch and 25Dₑₗₑₘₑₙₜ×25Dₑₗₑₘₑₙₜ total size. These arrays would yield an imaging radar picture of 25×25 pixels, covering for example a FOV of 75°×75° with 3° resolution.

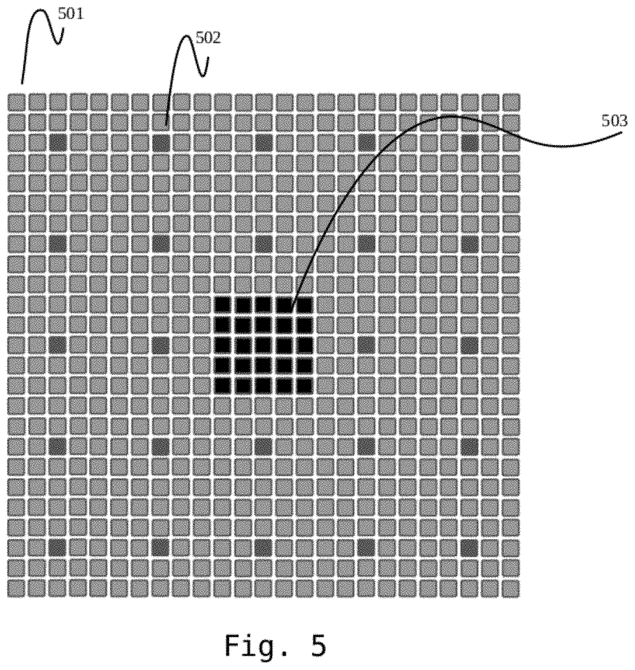

FIG. 5 shows an illustration of the transmitter antenna array elements 503 and the receiver antenna array elements 502 on a Dₑₗₑₘₑₙₜ grid 501 of the full 25×25 phased array that would be conventionally needed.

The system described in FIG. 5, using 50 total elements, provides a performance equivalent to a solution using a single transmitter and 1875 receivers, or 1875 transmitters and one receiver.

It is within provision of the invention that, as in FIG. 5, the transmit array be dense and the receive array sparse, or vice versa. For reasons of practicality it has been found that the former arrangement is useful.

It is within provision of the invention that the receive and transmit arrays be arranged in lines, curves, two-dimensional arrays, and three-dimensional arrays.

It is within provision of the invention that the arrays of the invention be implemented as patch antennas.

It is within provision of the invention that the apertures of the transmit and receive array be the same or different.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A phase array antenna system of improved angular resolution consisting of using geometric configurations for receiver and transmitter arrays that cause the peaks of the transmit signal to fall on the troughs of the receive signal lobes, causing a large cancellation of grating lobes.

2. A phase array antenna consisting of:
a. a receive antenna array comprising a plurality of antenna elements each having an aperture of Dₑₗₑₘₑₙₜ said receive array having an overall aperture of D_{RXarray}=NDₑₗₑₘₑₙₜ>>Dₑₗₑₘₑₙₜ, and said receive array having an element spacing of P_{Rx}=KDₑₗₑₘₑₙₜ>Dₑₗₑₘₑₙₜ;
b. a transmit antenna array, having an aperture of D_{Txarray}=P_{Rx}=KDₑₗₑₘₑₙₜ and a pitch of Dₑₗₑₘₑₙₜ;
wherein the entire field of view of said array is covered without any grating lobes, and wherein said transmit array can be used to select the correct main receive lobe direction so as to make the parasitic receive array grating lobes non-responsive, by causing the receiver grating lobes to fall on those angles where the transmitter pattern has nulls.

3. The phase array antenna of claim 2 with a configuration selected from the group consisting of: a dense transmit array and sparse receive array; a sparse transmit array and dense receive array; transmit array and receive array having the same pitch.

4. The phase array of claim 2 wherein said receive and transmit arrays be arranged in configurations selected from the group consisting of: lines; curves, two-dimensional arrays; and three-dimensional arrays.

5. The phase array of claim 2 wherein the pitches of said transmit antenna array and said receive antenna array lie between 1 mm and 1 m, adapted for transmission and reception in wavelengths ranging from microwave to radio wavelengths.

6. The phase array of claim 2 wherein said receive antenna array and said transmit antenna array are patch antennas adapted to be produced on a PCB having a ground plane.

7. A method for improved resolution in a phase array antenna, by providing geometric configurations for receiver and transmitter arrays that cause the peaks of the transmit signal to fall on the troughs of the receive signal lobes, causing a large cancellation of grating lobes.

8. A method for improved resolution in a phase array antenna consisting of:
a. providing a receive antenna array comprising a plurality of antenna elements each having an aperture of Dₑₗₑₘₑₙₜ, said receive array having an overall aperture of D_{RXarray}=NDₑₗₑₘₑₙₜ>>Dₑₗₑₘₑₙₜ, and said receive array having an element spacing of P_{Rx}=KDₑₗₑₘₑₙₜ>Dₑₗₑₘₑₙₜ;
b. providing a transmit antenna array, having an aperture of D_{Txarray}=P_{Rx}=KDₑₗₑₘₑₙₜ and a pitch of Dₑₗₑₘₑₙₜ;
wherein the entire field of view of said array is covered without any grating lobes, and wherein said transmit array can be used to select the correct main receive lobe direction so as to make the parasitic receive array grating lobes non-responsive, by causing the receiver grating lobes to fall on those angles where the transmitter pattern has nulls.

9. The method of claim 8 with a configuration selected from the group consisting of: a dense transmit array and sparse receive array; a sparse transmit array and dense receive array; transmit array and receive array having the same pitch.

10. The method of claim 8 wherein said receive and transmit arrays be arranged in configurations selected from the group consisting of: lines; curves, two-dimensional arrays; and three-dimensional arrays.

11. The method of claim 8 wherein the pitches of said transmit antenna array and said receive antenna array lie between 1 mm and 1 m, adapted for transmission and reception in wavelengths ranging from microwave to radio wavelengths.

12. The method claim 8 wherein said receive antenna array and said transmit antenna array are patch antennas adapted to be produced on a PCB having a ground plane.
